(19) United States
(12) Patent Application Publication
(10) Pub. No.: US 2012/0329561 A1
(43) Pub. Date: Dec. 27, 2012

(54) SYSTEM AND METHODS FOR GENERATING AVATARS AND ART

(75) Inventors: Andrew Blythe Evans, Lewisburg, WV (US); William FitzHugh, Rockville, MD (US)

(73) Assignee: Genomic Arts, LLC, Rockville, MD (US)

(21) Appl. No.: 13/315,352

(22) Filed: Dec. 9, 2011

Related U.S. Application Data
(60) Provisional application No. 61/421,273, filed on Dec. 9, 2010.

(51) Int. Cl. G06F 17/30; G06T 15/00; A63F 9/24; G06T 13/00

(52) U.S. Cl. 463/43; 345/473; 345/419; 707/736; 707/756; 707/E17.014

(57) ABSTRACT

A system and methods that enables the generation of avatars or art from users' own genetic information. Users may obtain their personal genomic information via direct-to-consumer (DTC) genotyping service or a full resequencing service. Users' genomic profile may be processed by a software algorithm that translates the genotypes into model phenotype descriptions based on a set of reconfigurable rules. Derived from the users' own DNA, phenotype descriptions may be used to create avatars that represent the users in online games and social media applications. Such phenotype descriptions can also be used to create games that are customized to the user, and to generate artwork.

This application claims priority to U.S. Provisional Patent Application No. 61/421,273 filed Dec. 9, 2010, the entire disclosure of which is incorporated herein by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates in general to the field of avatar and artwork generation, and in particular to novel systems and methods for generating avatars and artwork based on genomic information.

### BACKGROUND OF THE INVENTION

Avatar creation has consisted of using software programs to specify the attributes of an avatar. The attributes may determine the avatar's representation as displayed on a screen, and may correspond to physical features associated with the persona represented by the avatar. The attribute's values are usually set by either selecting from a list of options (hair color, gender, eye color, etc.) or entering values directly (height, weight, etc.). Graphical user interface components, such as sliders, dropdown lists, checkboxes, and radio buttons, may also be employed to set the avatar's attributes. The attribute values may be stored on the user's local computer and/or on a network server.

A random avatar generator may generate random values for the various avatar attributes. Such a random avatar generator may be employed to create an initial model that an user can then alter as needed. Otherwise, the user may define the avatar manually one attribute at a time. If a user wishes to create an avatar in his or her own likeness, he or she must determine the appropriate values.

Various software products have employed the manual method of avatar creation, including the following: Blizzard Entertainment's World of WarCraft online game; Sony's EverQuest game series; Linden Labs' Second Life virtual world; Nintendo's Wii game platform (Mii avatars); and, IAC/Mindspark's Zwinky brand.

Artwork has been produced from a DNA sample from an individual. For example, DNA11 Inc. of Ottawa, Ontario, Canada photographs a gel-based lab assay on a DNA sample to make a piece of artwork unique to the individual.

### BRIEF DESCRIPTION OF THE DRAWINGS

The foregoing and other objects, features, and advantages of the invention will be apparent from the following more particular description of embodiments as illustrated in the accompanying drawings, in which reference characters refer to the same parts throughout the various views. The drawings are not necessarily to scale, emphasis instead being placed upon illustrating principles of the invention.

FIG. 1 is an illustration of an example of an avatar generated from DNA genotype of a person.

FIG. 2 is a flow chart of an example of a process for generating an avatar from genetic information.

FIG. 3 shows an illustration of an example of DNA art generated in accordance with an embodiment of the invention.

FIG. 4 shows the high level architecture of a genomic database with an API to query trait values from an individual's genomic data.

### DETAILED DESCRIPTION OF THE EMBODIMENTS

Reference will now be made in detail to the embodiments of the present invention, examples of which are illustrated in the accompanying drawings.

In order to obtain one's genetic information, users may engage in Direct-To-Consumer (DTC) genomics, in accordance with an embodiment of the present invention. DTC genetic testing, known as at-home genetic testing, provides the public with access to their personal genetic information without necessarily involving a doctor. Any person can purchase a genetic test that is directly mailed to the consumer instead of being ordered through a doctor's office. The test may involve collecting a DNA sample, often by swabbing the inside of the cheek, and mailing the sample back to a laboratory. In an embodiment, the person may visit a health clinic to have blood drawn. Users may be notified of their results by mail, telephone, or online via e-mail or a website.

An objective of the invention in one embodiment is to allow people to use their own genetic information (derived from their own DNA) to create a representation of themselves (e.g., an avatar) for use in online games, virtual worlds, and social media applications. Such avatars may be used by DTC companies or game providers, such as Nintendo, as a marketing/recruitment or value-added retention feature. The invention can also be used to create forensic portraits of individuals, or for scientific visualization of genetic information.

In an embodiment, actual genomic information from nature (i.e., DNA derived from human tissue—such as blood or cheek cells, either from swabbing or saliva-borne) is used to drive the avatar creation process. The availability to the general public of inexpensive personal genomic data is a very new phenomenon—using the detailed genomic data from large numbers of people for entertainment purposes would have been inconceivable just a few years ago and the cost of acquiring the data is expected to continue to exponential spiral downward.

The present invention discloses a novel method for creating a software avatar and a novel model for a multiplayer online game. Further, the technology described here can be applied to scientific data visualization, personalized medicine decision-making, ancestry determination, clinical trial subject identification, biospecimen matching, and DNA forensics, as well.

In an embodiment, a method of the disclosed invention may include using actual genetic information from nature, processing it into a phenotype description, and using that to drive the avatar creation process. An embodiment of a system may include a genomically-driven avatar creator and a game world in which to utilize genomically-generated avatars.

An avatar may be a representation of a user within a software program run on a computer. Avatars may comprise a graphical representation of the user (and may be a realistic or fanciful depiction), and may include behaviors, animations, sounds, speech, gestures, motion, position and orientation within a virtual environment, and any parametric data that defines the avatar's interaction with the virtual environment. Avatars can range from static digital images used in online user profiles (like profile pictures in social networking and messaging programs) to fully realized three-dimensional character renderings in multiplayer online games or virtual worlds. The term avatar may also include any attributes of an online game character used by a player in the performance of the game, such as strength, dexterity, or abstract attributes including magic abilities that might be specific to the game but otherwise define the character's customized performance therein. In an embodiment, the method and/or system may also include the mapping of variation in these attributes to an individual's genetic variation.

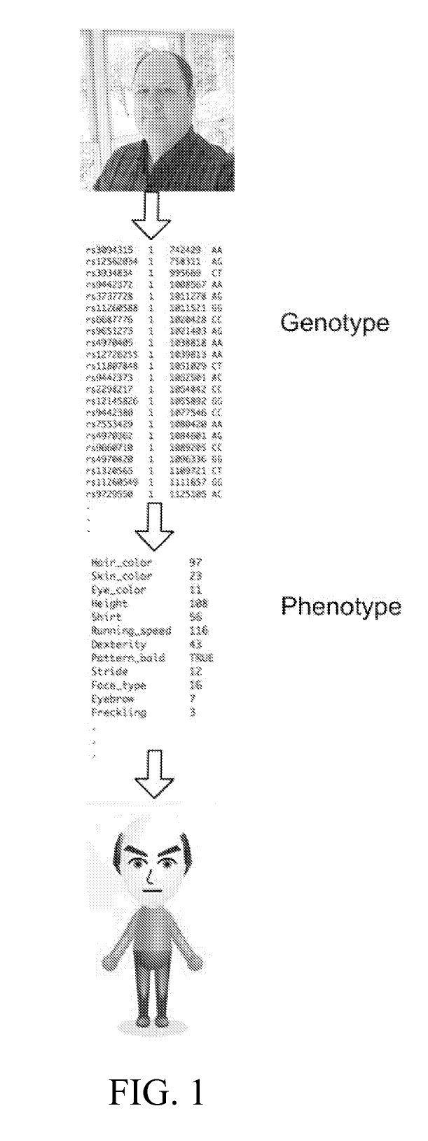

As shown in FIG. 1, an avatar may be generated from a DNA genotype of a subject. Genotype data is generated from a DNA sample from the subject. The genotype data is translated into a phenotype description. The phenotype description is then used by computer software to generate an avatar. While the subject in FIG. 1 is a person, the subject may be other living organisms, such as animals.

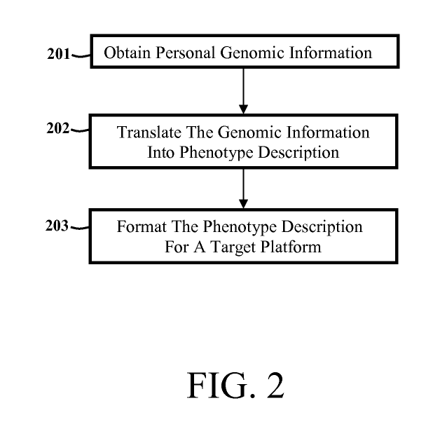

In an embodiment, the method includes generating an avatar by interpreting the user's actual human genomic information. FIG. 2 represents a flow chart of an example of such a process for generating an avatar from genetic information.

The process includes the step 201 whereby a user obtains his or her personal genomic information. This step may be accomplished by way of a Direct-to-consumer (DTC) genotyping service (such as 23andMe, deCODEme, Family Tree DNA, or a similar service) or by way of a full re-sequencing service (like Complete Genomics' or Illumina's re-sequencing offering). The method works equally well with microarray-based genotyping or genome re-sequencing, both of which can be used to identify variants of various types, including single nucleotide polymorphisms, insertions, deletions, translocations and microsatellite variants. Various methods and biological assays may be used to generate the genotype, including but not limited to PCR, DNA sequencing, ASO probes, and hybridization to DNA microarrays or beads.

The embodiment of the method also includes a step 202 whereby the user's genomic profile, as possibly obtained via the step described above, is processed by a software algorithm that translates the genotype into a model phenotype description based on a set of reconfigurable rules. In addition, the user's genomic profile may optionally be combined with other provided information, such as actual phenotype, age, or any other data deemed relevant.

The reconfigurable rules embody the transformation of specific genetic markers to phenotypic features and/or avatar behavioral parameters. The rules may also employ Boolean logic, confidence levels, and mathematical expressions. The software algorithm that uses these rules is a form of inference engine, such as a rule-driven “reasoner” or “interpreter” that draws conclusions about input data based on a rule-set. Each phenotypic feature is specified by the outcome of one or more rules in the rule-set.

The invention includes a method for deriving an arbitrary phenotype from a genotype (a ‘trait’). In some cases this might be a completely artificial phenotype, such as a number between 1 and 10, and in some cases it might be an approximation of a true phenotype, such as hair color. In any case, the phenotype value will be derived from the genotypes of one or more underlying variants. The specific variants that are used to derive the phenotype might be intentionally or randomly selected. Several methods can be used to create a phenotype or trait from a set of variant genotypes.

In some cases it will be desirable to create a numerical genotype for which the range of values approximates a normal, or Gaussian, distribution. Many traits in nature, such as height or vertical leap, are approximately normally distributed, in that average values are common and extreme values are less common. To create such a distribution, each genotype for a given variant can be assigned a numerical value, such as AA=0, AT=1, and TT=2. Those numerical values for a set of variants can be added together and, as stated in the Central Limit Theorem, the results for a number of individuals will produce an approximately normal distribution. The resulting value can be scaled appropriately to produce values from any specified range in any units.

In other cases a value from a linear distribution is desired. This is analogous to rolling a die to produce a value from 1 to 6, each value of which is equally likely. To create such a value from a number of variant genotypes, each allele for a variant will be assigned a value of 0 or 1, such as AA=00, AT=01, TT=11. The values for multiple variants are concatenated to create a binary number. For instance, 4 variants could be combined to create an 8-bit binary number, which can be translated to a decimal number. Different individuals' genotypes would create different numbers, but the results would approximate a linear distribution. In the case of an 8-bit number the range would be from 0 to 255, but the values could be scaled and/or translated to produce values from any specified range in any units.

Lastly, the values could be selected from a set of categorical values, such as red hair, brown hair and blonde hair. This could be accomplished simply by using the normal or linear distribution methods described above and assigning each resulting value to a category. However, more complex relationships between alleles and phenotypes are possible. The genotypes for a set of variants are used as input to a decision tree that applies logical operations to those genotypes and produces a categorical value as output. A trivial example is “IF variant1=AA THEN ‘RED HAIR’ ELSE ‘BROWN HAIR’” but any combination of nested and aggregated logical operations can be applied to look at many variants and produce many possible phenotypes. Prior biological knowledge of the phenotypes associated with genotypes could be used to create values that are potentially approximations of real physical traits (such as hair color) or medically relevant information (such as high or low risk of getting breast cancer).

These phenotypes, or traits, can then be used to control parameters of a software algorithm. Examples of software parameters that could be controlled by a trait are (but are not limited to) avatar physical attributes, such as hair color, skin color, eye color, pattern baldness, height, facial features, and clothing; event outcomes in electronic games; character attributes and abilities in role-playing games, such as strength, dexterity, resistance to disease or heat/cold, etc.; color, shape, texture, line length or other attributes of elements in software-generated artwork; musical pitch, duration, timbre, volume, tempo or other attributes of software-generated musical compositions; and rarity of virtual goods in electronic games and/or electronic social network systems.

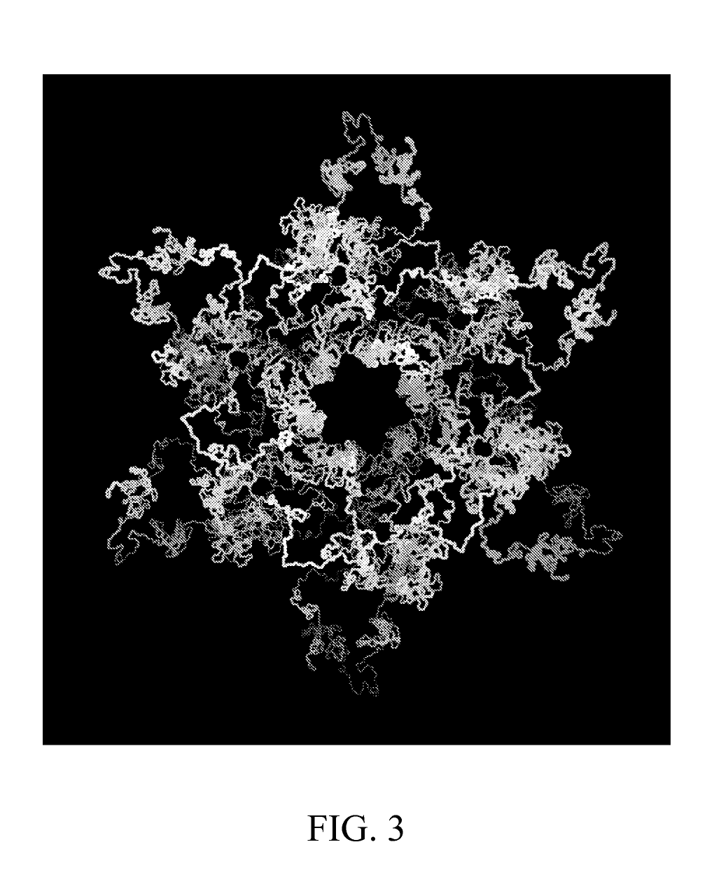

With further reference to the DNA art example and with reference to FIG. 3, the traits described above may be incorporated into an algorithm to create pieces of art that are essentially unique to an individual. An example is a picture based on a Koch Curve, in which a shape is created from a polygon by replacing each side of the polygon with a more complex series of connected line segments. The shape of that series of line segments is created by using underlying genotype information from an individual, using the genotypes of a series of variants to decide whether to turn left, turn right, or go straight when drawing the next line segment. In addition, the number of sides of the polygon, the colors used in the lines, and the width of the line segments are all generated from the underlying genotype information. This method uses thousands of variants in creating a picture so that each picture is extremely likely to be unique to the individual. Art produced in this general manner is not limited to two-dimensional (2-D) art but could also encompass three-dimensional (3-D) works or sequential art such as video or moving art installations. See FIG. 3.

Further, the method may include a step 203 whereby the output from the previous step can either be formatted to be directly usable by the target platform (in other words, a rendered image, a data file that is directly importable into a game or virtual world to be used to specify an avatar, etc.), or it can be formatted to be an intermediate data format that describes the output phenotype in a manner that can be translated later to any desired target format, for use on any platform. For example, an XML schema could be designed to describe a collection of phenotypes and an instance of such a schema could be generated from the genotype data. That XML file could be saved and used later as input to applications for avatar creation, art generation or game playing, for example.

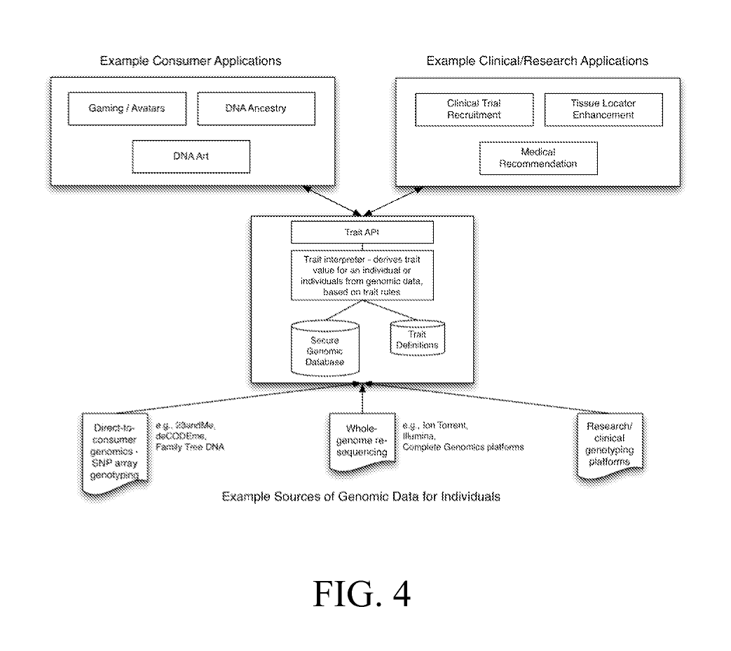

The method may include storing one or more definitions of traits in a database or library, for use by software programs. See FIG. 4. A collection of traits in such a database or library could be used separately or together to control parameters of a software algorithm. The client program could request a trait value or values for an individual or individuals, and the method would be employed to derive the appropriate trait value or values from the genomic data for the specified individual or individuals by applying the trait definitions using the techniques outlined above.

The system and method need not be limited to only online games and social media, avatar creation, or generation of works of art. The general process of applying a rule-based software transform to a genotype to derive a set of phenotypic features has broader application in areas such as scientific research, medicine and DNA forensics.

In research, the software transform could be applied to large sets of genomic information to produce visualizations that reveal genetic variation, based on flexible rules defined by researchers. For instance, a visualization that allowed a researcher to look at thousands of individuals and see how their genetic variation formed clusters or subpopulations within the population would be useful for making sense of high volumes of data. Such a visualization could use the entire genetic profile or it could be used to look only at variation in specific genes, genomic regions or functionally related sets of variants.

In forensics, a model for predicting actual phenotypes for victims or perpetrators of crimes could be defined in the rule-set, and refined as new research improves our understanding of the ways that genotype influences phenotype. A system could be created to create pictures of people from their genetic data to be used in identifying victims or criminals. Those pictures could be derived solely from genetic information, if that is all that is available, or combine known phenotype information about the individual with genetically-derived phenotypes. Unlike avatars, such pictures would be created to be as lifelike as possible. A system could also be created to make a virtual lineup in which multiple pictures were created, one from a genetic profile and the others created to be close matches in which a portion of the genetic profile was changed. This would allow investigators to understand how accurate the genetically-derived profile was by testing in cases where people had already seen the person in question.

In medicine, the software transform could be used to generate risk profiles for diseases that could be used by physicians and patients to guide lifestyle choices, predict drug reactions, and make treatment decisions. This system could, for example, show a patient and doctor what lifetime risks that patient had for a disease compared to the overall population. The system could also show a patient what drugs they might have adverse reactions to or be slow or fast metabolizers of, to guide a physician in prescribing the best medicine.

In ancestry, the software transform could be used to show an individual's ancestry based on genetic contributions from the their parents. Conserved blocks of DNA can show relative contributions from a variety of populations that can be linked to geographic regions and thus show where an individual's ancestors came from.

The software transform could be used to match patients to clinical trials based on a trait that defined the genetic criteria required for entry into clinical trials. Some clinical trials enroll only a subset of the population based on specific genetic differences that enable them to respond to the treatment being tested. A system could be created to match potential clinical trial participants to clinical trials and produce lists of patients that match each trial under consideration.

The software transform could be used to match biospecimens in a biobank to researchers requiring samples with specific genetic characteristics. If genetic information exists for such biospecimens, and researchers require access to a particular class of disease sample, or a particular population of individuals, such as system could be used to streamline the process of acquiring appropriate samples for research purposes.

Beyond the creation of avatars (either for a game tied closely to our process or for other platforms that use avatars), this technology can also be used to drive the gaming model for an entire game platform. In such a game, the artificial phenotype generated from the user's genotype information, as described above, could be used to affect many aspects of game play. Variations in genetic makeup could confer various abilities and benefits to players that might not necessarily correspond to the real-world genetic role of the genetic variation. For instance, carriers of a rare genetic variant may be given the ability fly in the game. Membership in social networks within the game (for instance, guilds, tribes, broader racial or national identities, etc.) could also be driven from the genotype, particularly through haplotyping. Human haplogroups could be mapped to in-game groups, for instance. Social groupings could be driven by other genetic factors that don't correspond to real-world haplogroups as well. For example, people suffering from a common Mendelian disease could be banded together as a “tribe” that could serve as a support group.

The anonymous genomic information of individuals can be collected, with appropriate consent, in a secure database, as shown in FIG. 4. As individuals share their actual phenotype information, this can also be stored in the database and associated with the individuals' genomic data to produce a valuable set of information for research use and which can be used to identify new genotype-phenotype associations. Such a database can be used to isolate the potentially sensitive genotype information from phenotypes by use of an application programming interface (API) that allows access only when a user name and password are supplied. The database could also store multiple versions of an individual's genotype, for instance from genome sequencing and microarray-based genotyping. The database could compare those multiple genotypes and calculate a genetic ‘distance’ from one genotype to all other genotypes in the database. This feature can be used to verify that two or more genotypes purported to be from the same individual are truly from that individual, or if they match genotypes purported to be from another individual. Coupled with verification of an individual's identity, such a database could become a trusted registry of genomic information and be used to keep others from impersonating an individual using their genetic information.

Embodiments of the disclosed system and method may involve various components of a computer system. The particular architecture or manner of interconnecting the components may vary. Certain systems may have fewer or more components. In one embodiment, a system may implement a central server and terminals. Other configurations are possible, as will be readily apparent to those skilled in the art.

A system may include an inter-connect (e.g., bus and system core logic), which interconnects a microprocessor(s) and memory. The microprocessor may be coupled to cache memory. The inter-connect may interconnect the microprocessor(s) and the memory together and also interconnects them to a display controller and display device and to peripheral devices such as input/output (I/O) devices through an input/output controller(s). Typical I/O devices include mice, keyboards, modems, network interfaces, printers, scanners, video cameras and other devices which are well known in the art.

The inter-connect may include one or more buses connected to one another through various bridges, controllers and/or adapters. In one embodiment the I/O controller includes a USB (Universal Serial Bus) adapter for controlling USB peripherals, and/or an IEEE-1394 bus adapter for controlling IEEE-1394 peripherals.

The memory may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, the central servers may be implemented using one or more data processing systems. In some embodiments, one or more servers of the system may be replaced with the service of a peer to peer network or a cloud configuration of a plurality of data processing systems, or a network of distributed computing systems. The peer to peer network, or cloud based server system, can be collectively viewed as a server data processing system.

Embodiments of the disclosure can be implemented via the microprocessor(s) and/or the memory. For example, the functionalities described above can be partially implemented via hardware logic in the microprocessor(s) and partially using the instructions stored in the memory. Some embodiments are implemented using the microprocessor(s) without additional instructions stored in the memory. Some embodiments are implemented using the instructions stored in the memory for execution by one or more general purpose microprocessor(s). Thus, the disclosure is not limited to a specific configuration of hardware and/or software.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as computer programs. Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer readable storage medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

By introducing the public to DTC genomics through a game, artwork or social-network, the disclosed system and method promotes a growing market for DTC genetic testing which may in-turn promote awareness of genetic diseases. As a result, the disclosed system and method allows consumers to take a more proactive role in their health care. In addition, this may offer a means for people to learn about their ancestral origins. Many people are turned off by the clinical and science emphasis of the current offerings. Some don't understand it, and others may be afraid to find out frightening facts about the potential condition of their health in the future. By associating genomics with games and social media, the lighter side of their genomic information may be explored to help them see how their genes make them unique, special, and part of a larger family.

Although systems and methods have been described above in language specific to structural features and/or methodological acts, it is to be understood that the subject matter defined in the appended claims is not necessarily limited to the specific features or acts described. Rather, the specific features and acts are disclosed as examples of implementations of the claimed methods, devices, systems, etc. It will be understood by those skilled in the art that various changes in form and details may be made therein without departing from the spirit and scope of the invention.

What is claimed is:

1. A method for using a computing device to generate an avatar from genomic information, comprising the steps of:
receiving in a computing device genomic information derived from human DNA associated with a user;
using said computing device to generate an avatar based on the genomic information, said avatar comprising a data set that can be used by a computer to represent said user.

2. The method of claim 1, wherein the genomic information corresponds to a trait or an ability of the avatar.

3. The method of claim 1, wherein the avatar is associated with a plurality of avatars based on associated genomic information.

4. The method of claim 3, wherein the associated genomic information is a disease.

5. The method of claim 3, wherein the associated genomic information corresponds to a trait or an ability of the avatar.

6. A method for using a computing device to create a gaming environment and game mechanics controlled in whole or in part by genomic information, comprising the steps of:
receiving in a computing device genomic information derived from human DNA associated with a user;
using said computing device to create one or more data sets that can be used by a computer to provide a gaming environment and game mechanics controlled in whole or in part by the genomic information.

7. The method of claim 6, wherein the genomic information is employed to control the value and/or rarity of virtual goods.

8. The method of creating a gaming environment and game mechanics according to claim 6, wherein the step of receiving genomic information associated with a user comprises receiving genomic information associated with a plurality of users.

9. A method for employing software for generating a work of art based on genomic information, comprising the steps of:
receiving in a computing device genomic information derived from human DNA associated with a user;
employing software running on said computing device to generate a digital work of art based on the genomic information, said digital work of art comprising a data set that can be used by a computer to display at least one two or three-dimensional image comprising artistic content.

10. A method for using a computing device to store genomic information in a database, comprising the steps:
associating genomic information with a user;
using a computing device to store the genomic information in a database;
using said computing device or another computing device to define traits, said traits corresponding either to a real phenotype or an artificial phenotype, said traits being derived from genomic features, based on a set of reconfigurable rules; and,
exposing an application programming interface to the database that allows software programs to query trait values from the user's genomic information without direct access to the user's genomic information.

11. The method of claim 10, wherein the database can store information from more than one genomic profile for a user.

12. The method of claim 10, wherein the database can store genomic information received from more than one genomic data supplier.

13. The method of claim 10, wherein the genomic information originates from a microarray assay.

14. The method of claim 10, wherein the genomic information originates from whole-genome or exome resequencing.

15. The method of claim 10, wherein the database implements methods to compare genomic multiple genomic profiles from a user and determines whether they are from the same individual.

16. The method of claim 10, wherein the database is used as registry of individuals to uniquely identify an individual based on genomic information.

17. The method of claim 16, wherein the database is used to compare multiple genotypes and calculate a genetic distance from one genotype to all other genotypes in the database, for the purpose of verifying that two or more genotypes purported to be from the same individual are truly from that individual, or if they match genotypes purported to be from another individual.

18. The method of claim 10, further comprising the step of:
generating a forensic image based on trait values queried from the database.

19. The method of claim 10, further comprising the step of:
generating a data visualization based on trait values queried from the database.

20. The method of claim 10, further comprising the step of:
generating an avatar based on trait values queried from the database.

21. The method of claim 10, further comprising the step of:
generating a work of art based on trait values queried from the database.

22. The method of claim 10, further comprising the step of:
generating a patient report for a physician describing disease risk profiles, adverse drug reaction predictions and other data to guide treatment, based on trait values queried from the database.

23. The method of claim 10, further comprising the step of:
generating a report of ancestry based on trait values queried from the database.

24. The method of claim 10, further comprising the step of:
generating a match to genetic criteria needed for a clinical trial based on trait values queried from the database.

25. The method of claim 10, further comprising the step of:
generating a match to a biospecimen in a tissue bank based on trait values queried from the database.

26. The method of claim 10, wherein the genomic information is received from a user.

27. The method of claim 26, wherein the genomic information is derived from Deoxyribonucleic acid (DNA).

28. The method of claim 27, wherein the DNA is collected from the user.

29. The method of claim 27, wherein the DNA is collected via Direct-To-Consumer (DTC) genetic testing.

30. The method of claim 10, wherein the target platform is a virtual world.

31. The method of claim 10, wherein the target platform is a video game.

32. The method of claim 31, wherein the video game is an online game.

33. The method of claim 10, wherein the target platform is a social network service.

34. The method of claim 33, wherein the social network service is selected from sites such as Facebook, Google+ and Twitter.

35. The method of claim 10, wherein the step of formatting the phenotype description for the target platform is based on reconfigurable rules.

36. The method of claim 10, further comprising the step:
combining the genomic information with phenotype information.

37. The method of claim 10, wherein the target platform is scientific research.

38. The method of claim 10, wherein the target platform is DNA forensics.

39. The method of claim 10, wherein the target platform is personalized medicine decision-making.

40. The method of claim 10, wherein the target platform is ancestry.

41. The method of claim 10, wherein the target platform is clinical trial participant identification.

42. The method of claim 10, wherein the target platform is biospecimen storage.

43. The method of claim 10, wherein the genomic information comprises a genomic profile, a collection of variants genotyped by technologies such as whole-genome sequencing or microarray.

44. The method of claim 10, further comprising the step:
collecting genomic information from a plurality of users.

45. The method of claim 44, wherein the collected genomic information is anonymous.

46. The method of claim 10, further comprising the step:
sharing the genomic information with a plurality of users.

47. The method of claim 10, wherein the database stores actual phenotype information collected from users.

48. The method of claim 10, wherein the database is used to generate new genotype-phenotype associations.

49. The method of claim 10, wherein trait values queried from the database are persisted in an intermediary data file in a manner that can be later translated into another desired format for a target platform.

50. Computer program process code, tangibly stored on at least one non-transitory computer readable medium, the computer program process code comprising instructions implementing a method for using a computing device to generate an avatar from genomic information, comprising instructions for:
receiving in a computing device genomic information derived from human DNA associated with a user; and,
generating an avatar based on the genomic information, said avatar comprising a data set that can be used by a computer to represent said user.
